(19) United States
(12) Patent Application Publication
(10) Pub. No.: US 2025/0175879 A1
(43) Pub. Date: May 29, 2025

(54) METHOD AND APPARATUS FOR FORWARDING CONTROL INFORMATION IN MOBILE COMMUNICATIONS

(71) Applicant: MEDIATEK INC., Hsinchu City (TW)

(72) Inventors: Cheng-Rung TSAI, Hsinchu City (TW); Lung-Sheng TSAI, Hsinchu City (TW)

(21) Appl. No.: 18/834,409

(22) PCT Filed: Mar. 27, 2023
(86) PCT No.: PCT/CN2023/084065

§ 371 Date: Jul. 30, 2024

Related U.S. Application Data
(60) Provisional application No. 63/328,772, filed on Apr. 8, 2022.
(60) Provisional application No. 63/335,243, filed on Apr. 27, 2022.
(60) Provisional application No. 63/352,338, filed on Jun. 15, 2022.

(51) Int. Cl. H04W 40/22; H04W 40/04

(52) U.S. Cl. CPC H04W 40/22; H04W 40/04

(57) ABSTRACT

Method and apparatus are provided for forwarding control information. In one novel aspect, a base station (BS) transmits a configuration of a forwarding resource to a repeater. The configuration includes a time domain occasion information and a spatial setting. The repeater receives the configuration of the forwarding resource. Then, the BS transmits a signal to the repeater, and the repeater forwards the signal to a user equipment (UE) based on the forwarding resource.

### CROSS REFERENCE TO RELATED APPLICATIONS

This application claims priority under 35 U.S.C. § 119 from U.S. Provisional Application No. 63/328,772, entitled “Control Information for Network-Controlled Forwarding,” filed on Apr. 8, 2022, U.S. Provisional Application No. 63/335,243, filed on Apr. 27, 2022, and U.S. Provisional Application No. 63/352,338, entitled “Control Information for Network-Controlled Forwarding,” filed on Jun. 15, 2022, the subject matter of which is incorporated herein by reference.

### TECHNICAL FIELD

The disclosed embodiments relate generally to wireless communication, and, more particularly, to method, repeater and base station for forwarding control information in mobile communications.

### BACKGROUND

In conventional network of 3rd generation partnership project (3GPP) 5G new radio (NR), for enhancing the coverage of NR network communication, a repeater may be introduced in the NR network. In particular, the repeater with compatibility of legacy user equipment and lower cost of deployment may be deployed in the NR network for forwarding information from a base station to a user equipment. However, the details of introducing the repeater in the NR network have not been fully discussed yet and some issues need to be solved.

### SUMMARY

In one embodiment, a method, a repeater and a base station are provided for forwarding control information. In particular, the base station transmits a configuration of a forwarding resource set including at least one forwarding resource to the repeater. The at least one forwarding resource includes a time domain occasion information. The repeater receives the configuration of the forwarding resource set. Then, the base station: (1) transmits a signal to the repeater, and the repeater forwards the signal based on the forwarding resource; or (2) receives a signal from the repeater based on the forwarding resource.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary 5G new radio network supporting repeater forwarding information in accordance with embodiments of the current invention.

FIG. 2 is a simplified block diagram of the base station and the repeater in accordance with embodiments of the current invention.

FIG. 3A illustrates one embodiment of message transmissions in accordance with embodiments of the current invention.

FIG. 3B illustrates one embodiment of message transmissions in accordance with embodiments of the current invention.

FIGS. 4A and 4B illustrate one example of beam training based on the received configurations in accordance with one novel aspect.

FIGS. 4C and 4D illustrate one example of signal transmission after beam training in accordance with one novel aspect.

FIG. 5 is a flow chart of a method of a repeater for forwarding information in accordance with one novel aspect.

FIGS. 6A, 6B and 6C are flow charts of a method of a repeater for forwarding information in accordance with one novel aspect.

### DETAILED DESCRIPTION

Reference will now be made in detail to some embodiments of the invention, examples of which are illustrated in the accompanying drawings.

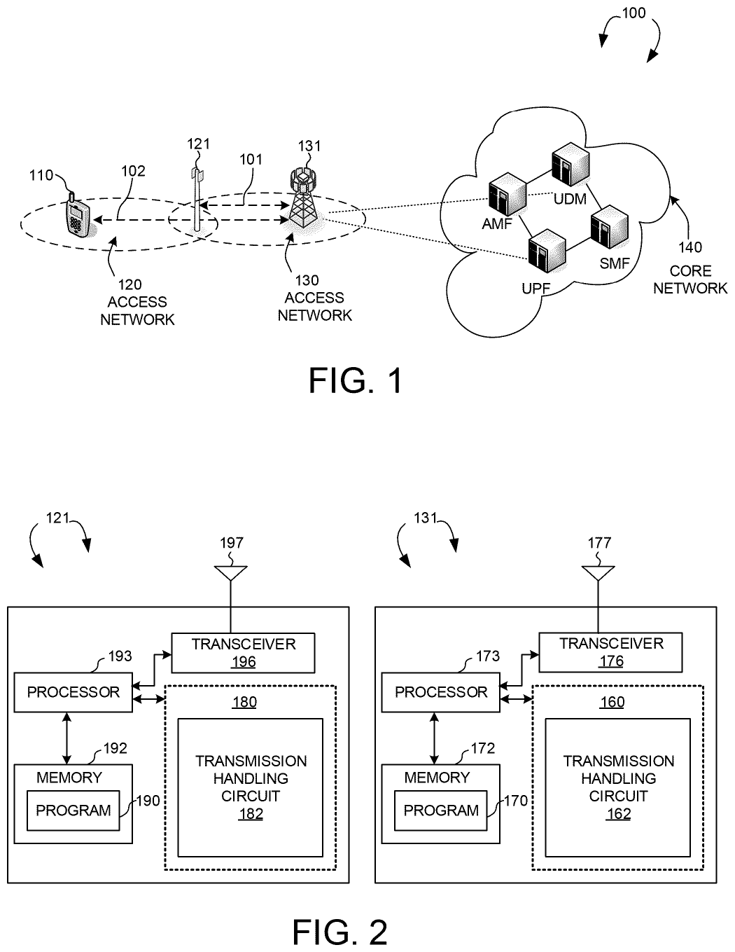

FIG. 1 illustrates an exemplary 5G new radio (NR) network 100 supporting repeater for forwarding information in accordance with aspects of the current invention. The 5G NR network 100 includes a user equipment (UE) 110, a repeater 121, a gNB 131 and a 5G core network 140. Via an amplify-and-forward (AF) function of the repeater 121 operating an access network 120, the UE 110 is communicatively connected to the gNB 131 operating in a licensed band (e.g., 30 GHz˜300 GHz for mmWave) of an access network 130 which provides radio access using a Radio Access Technology (RAT) (e.g., the 5G NR technology). The access network 130 is connected to the 5G core network 140 by means of the NG interface, more specifically to a User Plane Function (UPF) by means of the NG user-plane part (NG-u), and to a Mobility Management Function (AMF) by means of the NG control-plane part (NG-c). One gNB can be connected to multiple UPFs/AMFs for the purpose of load sharing and redundancy. The UE 110 may be a smart phone, a wearable device, an Internet of Things (IoT) device, and a tablet, etc. Alternatively, UE 110 may be a Notebook (NB) or Personal Computer (PC) inserted or installed with a data card which includes a modem and RF transceiver(s) to provide the functionality of wireless communication.

The gNB 131 may provide communication coverage for a geographic coverage area in which communications with the repeater 121. The repeater 121 may provide communication coverage for a geographic coverage area in which communications with the UE 110. A control link 101 shown in the 5G NR network 100 may be established between the repeater 121 and the gNB 131. An AF link 102 shown in the 5G NR network 100 may be established between the UE 110 and the gNB 131 via the repeater 121. The control link 101 may be used for transmitting network parameters associated with the AF link 102 to control the AF link 102. The AF link 102 may include UL transmissions from the UE 110 to the gNB 131 (e.g., on the Physical Uplink Control Channel (PUCCH) or Physical Uplink Shared Channel (PUSCH)) or DL transmissions from the gNB 131 to the UE 110 (e.g., on the Physical Downlink Control Channel (PDCCH) or Physical Downlink Shared Channel (PDSCH)).

It should be noted that, the control link 101 may be utilized for transmitting capability reports of the control link 101 and the AF link 102 to the gNB 131. The capability report of the control link 101 may be related to Layer1/Layer2/Layer3 control information of receiver/transmitter. The capability report of the AF link 102 may be related to DL/UL multi-input multi-output (MIMO), DL/UL carrier aggregation (CA) and maximum DL/UL power gain.

Radio resource control (RRC) configuration for the control link 101 may be related to Layer1/Layer2/Layer3 control information of receiver/transmitter; applied DL/UL power gain for the AF link 102. Measurements to maintain the control link 101 may be related to radio resource measurement (RRM); radio link monitoring (RLM); channel state information (CSI); and sounding reference signal (SRS).

Layer1 control information may include: group common-PDCCH (GC-PDCCH) for slot format indication related to the control link 101 and the AF link 102; DL/UL beam indication related to the control link 101 and the AF link 102; scheduling downlink control information (DCI) for Llayer2/Llayer3 messages related to the control link 101; UL power control command for Layer2/Layer3 messages related to the control link 101; scheduling request (SR) and hybrid automatic repeat request acknowledgement (HARQ-ACK) for Layer2/Layer3 messages related to the control link 101; PDCCH order for timing advance (TA) maintenance for the control link 101; and CSI report and SRS for the control link 101.

Layer2 control information may include: DL/UL beam indication related to the control link 101 and the AF link 102; and random access response (RAR) related to the control link 101. Layer3 control information may include: L3: time-division duplex (TDD) configuration related to the control link 101 and the AF link 102; DL/UL beam configuration related to the control link 101 and the AF link 102; other configurations related to the control link 101.

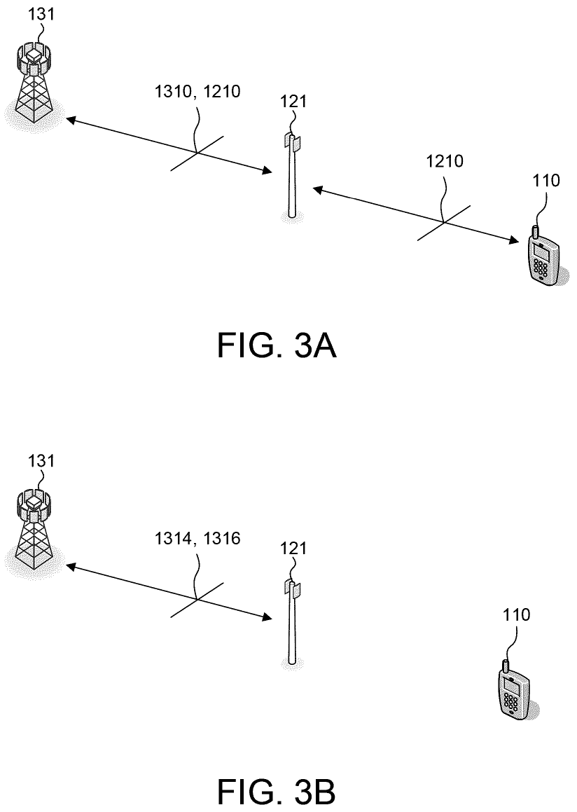

FIG. 2 is a simplified block diagram of the repeater 121 and the gNB 131 in accordance with embodiments of the present invention. For the repeater 121, an antenna 197 transmits and receives radio signal. A radio frequency (RF) transceiver module 196, coupled with the antenna, receives RF signals from the antenna, converts them to baseband signals and sends them to processor 193. RF transceiver 196 also converts received baseband signals from the processor 193, converts them to RF signals, and sends out to antenna 197. Processor 193 processes the received baseband signals and invokes different functional modules and circuits to perform features in the repeater 121. Memory 192 stores program instructions and data 190 to control the operations of the repeater 121.

Similarly, for the gNB 131, an antenna 177 transmits and receives RF signal. RF transceiver module 176, coupled with the antenna, receives RF signals from the antenna, converts them to baseband signals and sends them to processor 173. RF transceiver 176 also converts received baseband signals from the processor 173, converts them to RF signals, and sends out to antenna 177. Processor 173 processes the received baseband signals and invokes different functional modules and circuits to perform features in the gNB 131. Memory 172 stores program instructions and data 170 to control the operations of the gNB 131.

The repeater 121 and the gNB 131 include several functional modules and circuits that can be implemented and configured to perform embodiments of the present invention. In the example of FIG. 2, the repeater 121 includes a set of control functional modules and circuit 180. Transmission handling circuit 182 handles amplifying-forwarding DL/UL transmissions and associated network parameters for the UE 110 and the gNB 131. The gNB 131 includes a set of control functional modules and circuit 160. Transmission handling circuit 162 handles DL/UL transmissions and associated network parameters for the UE 110 and the repeater 121.

Note that the different functional modules and circuits can be implemented and configured by software, firmware, hardware, and any combination thereof. The function modules and circuits, when executed by the processors 193 and 173 (e.g., via executing program codes 190 and 170), allow the repeater 121 and the gNB 131 to perform embodiments of the present invention.

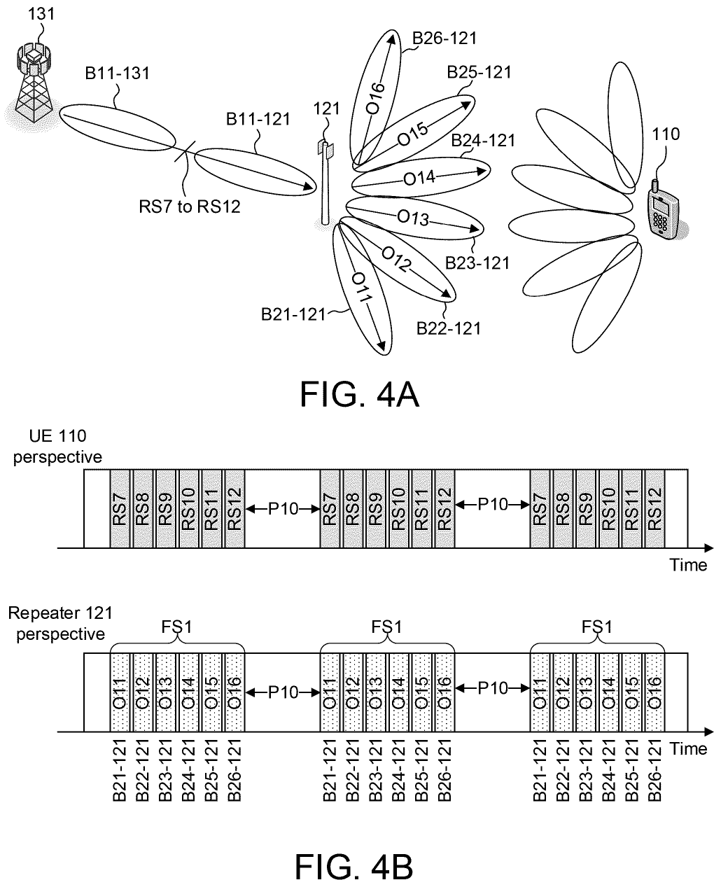

FIG. 3A illustrates one embodiment of message transmissions in accordance with one novel aspect. In particular, the gNB 131 transmits a higher layer configuration (e.g., RRC configuration) to the repeater 121. The higher layer configuration includes a forwarding resource set 1310 of forwarding resource(s), and the forwarding resource(s) includes a time domain occasion information.

The repeater 121 receives the higher layer configuration, and derives, from the forwarding resource set 1310 including the forwarding resource(s) and the time domain occasion information. Accordingly, the repeater 121 may forward a signal 1210 from the gNB 131 to the UE 110 or from the UE 110 to the gNB 131 based on the time domain occasion information associated with the forwarding resource(s) of the forwarding resource set 1310.

In some implementations, the time domain occasion information of the configuration 1310 includes at least one of: (1) a slot offset of a slot and at least one symbol location in the slot; and (2) a periodicity of time domain occasion information.

In some implementations, the forwarding resource(s) further includes a first spatial setting and the first spatial setting includes at least one of: (1) a beam index; (2) a transmission configuration indication (TCI) state identification; (3) an index of another forwarding resource; (4) an absent indication; and (5) an indication of state without QCL assumption or beam indication.

In some implementations, the forwarding resource(s) further includes: (1) a forwarding resource index of the forwarding resource; (2) a forwarding type indicating uplink (UL) transmission or downlink (DL) transmission; (3) a forwarding state indicating forwarding activation or forwarding deactivation; and (4) a power control setting.

In some embodiments, the configuration 1310 of the higher layer configuration further includes a list of forwarding resource index(es) corresponding to the forwarding resource(s).

In some embodiments, the configuration 1310 of the higher layer configuration further includes at least one of: (1) a forwarding resource set index of the forwarding resource set; (2) a periodicity for every forwarding resource (i.e., for all forwarding resource(s)) of the forwarding resource set; (3) a slot offset for every forwarding resource (i.e., for all forwarding resource(s)) of the forwarding resource set; (4) a time domain setting (e.g., periodic, semi-persistent, or aperiodic) of the forwarding resource set; and (5) an indication of using a same beam for every resource forwarding resource (i.e., for all forwarding resource(s)) of the forwarding resource set or using different beams for different forwarding resources of the forwarding resource set.

FIG. 3B illustrates one embodiment of message transmissions in accordance with one novel aspect. In some embodiments, for updating the configurations, the repeater 121 receives a media access control-control element (MAC-CE) 1314 from the gNB 131. The MAC-CE 1314 includes at least one of: (1) the forwarding resource set index of the forwarding resource set including the forwarding resource(s); (2) an indication of activation of the forwarding resource set or deactivation of the forwarding resource set; (3) a list of second spatial setting(s) for the forwarding resource(s) in the forwarding resource set; (4) a bandwidth part identification for which the MAC-CE applies; and (5) a component carrier identification for which the MAC-CE applies.

In some embodiments, for updating the configurations, the repeater 121 receives a DCI 1316 from the gNB 1316. The DCI 1316 includes: (1) a list of forwarding resource index(es) corresponding to the forwarding resource(s); and (2) a list of second spatial setting(s) for the forwarding resource(s).

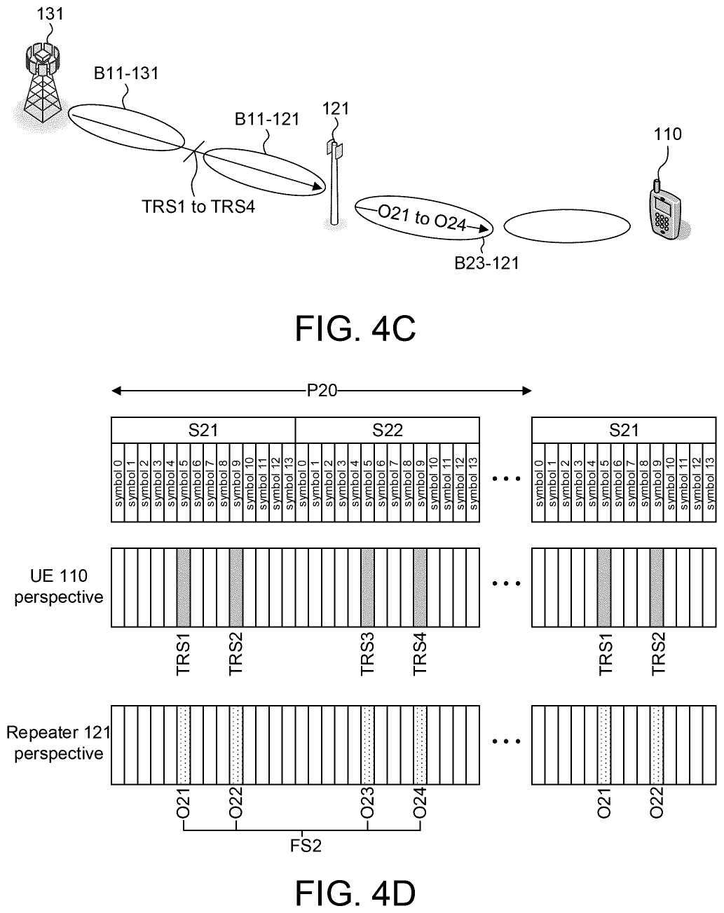

FIGS. 4A and 4B illustrate one example of beam training based on the received configurations in accordance with one novel aspect. In particular, the gNB 131 and the repeater 121 communicate with each other via a beam B11-131 of the gNB 131 and a beam B11-121 of the repeater 121. In this example, the beam pair of the beam B11-131 and the beam B11-121 is determined by the gNB 121 and may not be changed since the locations of the gNB 131 and the repeater 121 are fixed.

Then, based on the received configuration 1310, the repeater 121 determines: (1) a forwarding resource set FS1 having forwarding resources O11 to O16; (2) the time domain occasions of the forwarding resources O11 to O16; (3) beams B21-121 to B26-121 which respectively correspond to the forwarding resources O11 to O16 (e.g., beam indexes of beams B21-121 to B26-121 respectively correspond to the forwarding resources O11 to O16); and (4) a periodicity P10 configured to the forwarding resource set FS1.

Accordingly, when the gNB 131 transmits DL reference signals (RSs) RS7 to RS12, which are aligned with the time domain occasions of the forwarding resources O11 to O16, to the repeater 121, the repeater 121 forwards the RSs RS7 to RS12 on the time domain occasions of the forwarding resources O11 to O16 with corresponding beams B21-121 to B26-121 respectively.

More specifically, the repeater 121 forwards: (1) the RS RS7 on the time domain occasion of the forwarding resource O11 with corresponding beam B21-121 from the gNB 131 to the UE 110; (2) the RS RS8 on the time domain occasion of the forwarding resource O12 with corresponding beam B22-121 from the gNB 131 to the UE 110; (3) the RS RS9 on the time domain occasion of the forwarding resource O13 with corresponding beam B23-121 from the gNB 131 to the UE 110; (4) the RS RS10 on the time domain occasion of the forwarding resource O14 with corresponding beam B24-121 from the gNB 131 to the UE 110; (5) the RS RS11 on the time domain occasion of the forwarding resource O15 with corresponding beam B25-121 from the gNB 131 to the UE 110; and (6) the RS RS12 on the time domain occasion of the forwarding resource O16 with corresponding beam B26-121 from the gNB 131 to the UE 110.

Then, according to the forwarded RSs RS7 to RS12, the UE 110 performs DL measurements on the DL RSs RS7 to RS12, and reports one with the best quality to the gNB 131. In this example, the UE 110 reports the RS RS9 with the best quality to the gNB 131.

According to the report from the UE 110, the gNB 131 determines that the beam B23-121, which corresponds to time domain occasion of the forwarding resource O13 aligned with the RS RS9, is used as the serving beam for the repeater 121 to forward information to/from the UE 110. The gNB 131 transmits: (1) an indication of using the beam B23-121 to the repeater 121; and (2) an indication of RS RS9 for DL and UL to the UE 110.

FIGS. 4C to 4D illustrate one example of signal transmission after beam training in accordance with one novel aspect. In particular, the gNB 131 and the repeater 121 communicate with each other via the beam B11-131 of the gNB 131 and the beam B11-121 of the repeater 121. After the beam training, the repeater 121 ad the UE 110 communicate with each other via the beam B23-121 of the repeater 121 and a beam B23-110, which is determined by the UE 110 based on the RS RS9, of the UE 110.

Then, based on the received configurations 1310 and 1312, the repeater 121 determines: (1) a forwarding resource set FS2 having forwarding resources O21 to O24; (2) the time domain occasions of the forwarding resources O21 to O24 in slots S21 and S22; and (3) a periodicity P20 configured to the forwarding resource set FS2.

Accordingly, when the gNB 131 transmits tracking reference signals (TRSs) (e.g., CSI-RS) TRS1 to TRS4, which are aligned with the time domain occasions of the forwarding resources O21 to O24, to the repeater 121, the repeater 121 forwards the TRSs TRS1 to TRS4 on the time domain occasions of the forwarding resources O21 to O24 by the beam B23-121. Then, according to the TRSs TRS1 to TRS4, the UE 110 performs DL measurements on the TRSs TRS1 to TRS4 based on RS RS9 indicated by the gNB 131.

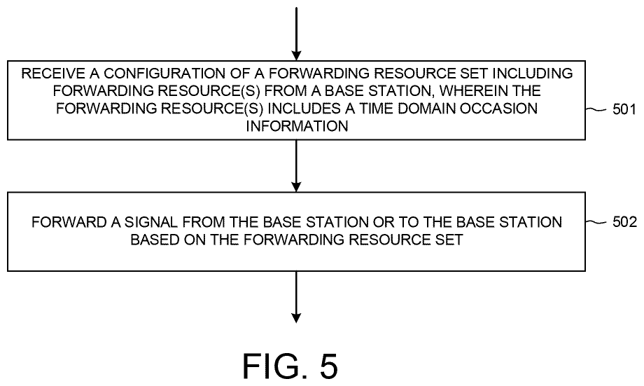

FIG. 5 is a flow chart of a method of a repeater for forwarding information in accordance with one novel aspect. In step 501, a repeater receives a configuration of a forwarding resource set including forwarding resource(s) from a base station. The forwarding resource(s) includes a time domain occasion information. In step 502, the repeater forwards a signal from the base station or to the base station based on the forwarding resource set.

In some implementations, the time domain occasion information includes at least one of: (1) a slot offset of a slot and at least one symbol location in the slot; and (2) a periodicity of time domain occasion information.

In some implementations, the forwarding resource(s) includes a spatial setting and the spatial setting includes at least one of: (1) a beam index; a transmission configuration indication (TCI) state identification; (2) an index of another forwarding resource; (3) an absent indication; and (4) an indication of state without QCL assumption or beam indication.

In some implementations, the forwarding resource(s) further includes: (1) a forwarding resource index of the forwarding resource; (2) a forwarding type indicating uplink transmission or downlink transmission; (3) a forwarding state indicating forwarding activation or forwarding deactivation; and (4) a power control setting.

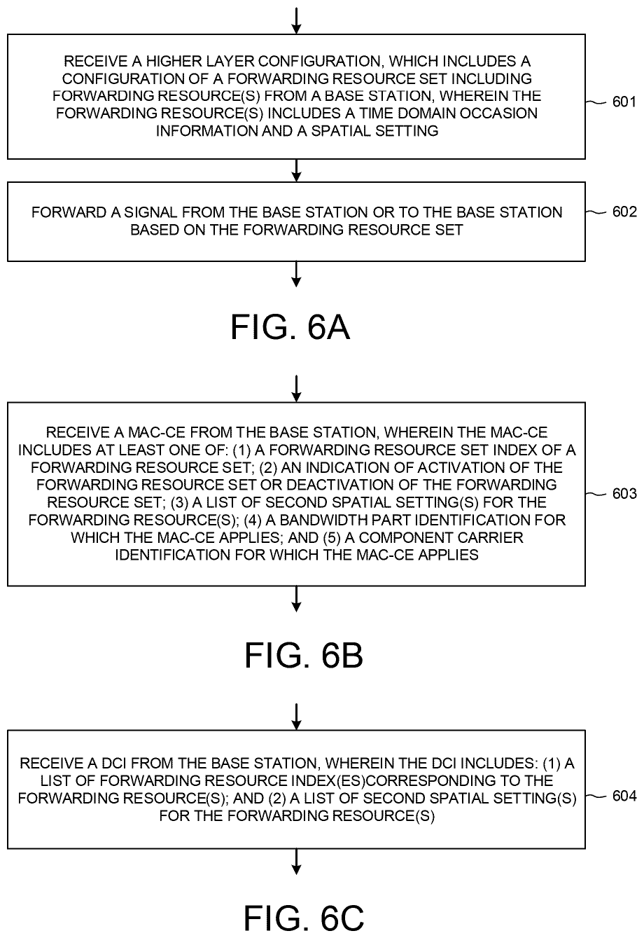

FIGS. 6A to 6C are flow charts of a method of a repeater for forwarding information in accordance with one novel aspect. In step 601, a repeater receives a higher layer configuration, which includes a configuration of a forwarding resource set including forwarding resource(s) from a base station. The forwarding resource(s) includes a time domain occasion information and a first spatial setting. In step 602, the repeater forwards a signal from the base station or to the base station based on the forwarding resource set.

In some implementations, the configuration includes a list of forwarding resource index(es) corresponding to the forwarding resource(s).

In some implementations, the configuration includes: (1) a forwarding resource set index of the forwarding resource set; (2) a periodicity for every forwarding resource of the forwarding resource set; (3) a slot offset for every forwarding resource of the forwarding resource set; (4) a time domain setting of the forwarding resource set; and (5) an indication of using a same beam for every resource forwarding resource of the forwarding resource set or using different beams for different forwarding resources of the forwarding resource set.

In some embodiments, the method of the repeater for forwarding information optionally includes step 603. In step 603, the repeater receives a MAC-CE from the base station. The MAC-CE includes at least one of: (1) a forwarding resource set index of a forwarding resource set; (2) an indication of activation of the forwarding resource set or deactivation of the forwarding resource set; (3) a list of second spatial setting(s) for the forwarding resource(s) in the forwarding resource set; (4) a bandwidth part identification for which the MAC-CE applies; and (5) a component carrier identification for which the MAC-CE applies.

In some embodiments, the method of the repeater for forwarding information optionally includes step 604. In step 604, the repeater receives a DCI from the base station. The DCI includes: (1) a list of forwarding resource index(es) corresponding to the forwarding resource(s); and (2) a list of second spatial setting(s) for the forwarding resource(s).

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
receiving, by a repeater, a configuration of a forwarding resource set comprising at least one forwarding resource from a base station, wherein the at least one forwarding resource includes a time domain occasion information; and
forwarding, by the repeater, a signal from the base station or to the base station based on the forwarding resource set.

2. The method of claim 1, wherein the time domain occasion information includes:
a slot offset of a slot and at least one symbol location in the slot.

3. The method of claim 1, wherein the at least one forwarding resource further includes a first spatial setting, and the first spatial setting includes at least one of:
a beam index;
a transmission configuration indication (TCI) state identification;
an index of another forwarding resource;
an absent indication; and
an indication of state without QCL assumption or beam indication.

4. The method of claim 1, wherein the at least one forwarding resource further includes at least one of:
a forwarding resource index of the forwarding resource;
a forwarding type indicating uplink transmission or downlink transmission;
a forwarding state indicating forwarding activation or forwarding deactivation; and
a power control setting.

5. The method of claim 1, wherein the configuration further includes:
a list of at least one forwarding resource index corresponding to the at least one forwarding resource.

6. The method of claim 1, wherein the configuration further includes at least one of:
a forwarding resource set index of the forwarding resource set;
a periodicity for every forwarding resource of the forwarding resource set;
a slot offset for every forwarding resource of the forwarding resource set;
a time domain setting of the forwarding resource set; and
an indication of using a same beam for every resource forwarding resource of the forwarding resource set or using different beams for different forwarding resources of the forwarding resource set.

7. The method of claim 6, further including:
receiving, by the repeater, a media access control-control element (MAC-CE) from the base station, wherein the MAC-CE includes at least one of:
the forwarding resource set index of the forwarding resource set;
an indication of activation of the forwarding resource set or deactivation of the forwarding resource set;
a list of at least one second spatial setting for the at least one forwarding resource in the forwarding resource set;
a bandwidth part identification for which the MAC-CE applies; and
a component carrier identification for which the MAC-CE applies.

8. The method of claim 1, further including:
receiving, by the repeater, a downlink control information (DCI) from the base station, wherein the DCI includes:
a list of at least one forwarding resource index corresponding to the at least one forwarding resource; and
a list of at least one second spatial setting for the at least forwarding resource.

9. A repeater, comprising:
a transceiver; and
a transmission handling circuit that:
receives, via the transceiver, a configuration of a forwarding resource set comprising at least one forwarding resource from a base station, wherein the at least one forwarding resource includes a time domain occasion information; and
forwards, via the transceiver, a signal from the base station or to the base station based on the forwarding resource set.

10. The repeater of claim 9, wherein the time domain occasion information includes:
a slot offset of a slot and at least one symbol location in the slot.

11. The repeater of claim 9, wherein the at least one forwarding resource further includes a first spatial setting, and the first spatial setting includes at least one of:
a beam index;
a transmission configuration indication (TCI) state identification;
an index of another forwarding resource;
an absent indication; and
an indication of state without QCL assumption or beam indication.

12. The repeater of claim 9, wherein the at least one forwarding resource further includes at least one of:
a forwarding resource index of the forwarding resource;
a forwarding type indicating uplink transmission or downlink transmission;
a forwarding state indicating forwarding activation or forwarding deactivation; and
a power control setting.

13. The repeater of claim 9, wherein the configuration further includes:
a list of at least one forwarding resource index corresponding to the at least one forwarding resource.

14. The repeater of claim 9, wherein the configuration further includes at least one of:
a forwarding resource set index of the forwarding resource set;
a periodicity for every forwarding resource of the forwarding resource set;
a slot offset for every forwarding resource of the forwarding resource set;
a time domain setting of the forwarding resource set; and
an indication of using a same beam for every resource forwarding resource of the forwarding resource set or using different beams for different forwarding resources of the forwarding resource set.

15. The repeater of claim 14, wherein the transmission handling circuit further:
receives, via the transceiver, a media access control-control element (MAC-CE) from the base station, wherein the MAC-CE includes at least one of:
the forwarding resource set index of the forwarding resource set;
an indication of activation of the forwarding resource set or deactivation of the forwarding resource set;
a list of at least one second spatial setting for the at least one forwarding resource in the forwarding resource set;
a bandwidth part identification for which the MAC-CE applies; and
a component carrier identification for which the MAC-CE applies.

16. The repeater of claim 9, the transmission handling circuit further:
receives, via the transceiver, a downlink control information (DCI) from the base station, wherein the DCI includes:
a list of at least one forwarding resource index corresponding to the at least one forwarding resource; and
a list of at least one second spatial setting for the at least forwarding resource.

17. A base station, comprising:
a transceiver; and
a transmission handling circuit that:
transmits, via the transceiver, a configuration of a forwarding resource set comprising at least one forwarding resource to a repeater, wherein the at least one forwarding resource includes a time domain occasion information; and
transmits or receives, via the transceiver, a signal to or from the repeater based on the forwarding resource set.

18. The base station of claim 17, wherein the at least one forwarding resource further includes a first spatial setting, and the first spatial setting includes at least one of:
a beam index;
a transmission configuration indication (TCI) state identification;
an index of another forwarding resource;
an absent indication; and
an indication of state without QCL assumption or beam indication.

19. The base station of claim 17, wherein the transmission handling circuit further:
transmits, via the transceiver, a media access control-control element (MAC-CE) to the repeater, wherein the MAC-CE includes at least one of:
a forwarding resource set index of the forwarding resource set;
an indication of activation of the forwarding resource set or deactivation of the forwarding resource set;
a list of at least one second spatial setting for the at least one forwarding resource in the forwarding resource set;
a bandwidth part identification for which the MAC-CE applies; and
a component carrier identification for which the MAC-CE applies.

20. The base station of claim 17, the transmission handling circuit further:
transmits, via the transceiver, a downlink control information (DCI) to the repeater, wherein the DCI includes:
a list of at least one forwarding resource index corresponding to the at least one forwarding resource; and
a list of at least one second spatial setting for the at least forwarding resource.
